(19) United States
(12) Patent Application Publication
(10) Pub. No.: US 2019/0297666 A1
(43) Pub. Date: Sep. 26, 2019

(54) SYSTEM FOR PRIORITIZING EMERGENCY SERVICES WITHIN A SELF ORGANIZING NETWORK

(71) Applicant: CABLE TELEVISION LABORATORIES, INC., Louisville, CO (US)

(72) Inventors: Bernard McKibben, Golden, CO (US); Neeharika Allanki, Boulder, CO (US); Vikas Sarawat, Broomfield, CO (US)

(21) Appl. No.: 16/442,185

(22) Filed: Jun. 14, 2019

Related U.S. Application Data
(63) Continuation of application No. 14/945,267, filed on Nov. 18, 2015, now abandoned.

(51) Int. Cl. H04W 76/50; H04W 72/10; H04W 4/90; H04W 24/02

(52) U.S. Cl. CPC H04W 76/50; H04W 72/10; H04W 84/22; H04W 24/02; H04W 4/90

(57) ABSTRACT

A Wi-Fi enabled Self Organizing Network system configured for prioritizing communication resources to emergency services communications is provided. The present system controls communication resources based on data from a communication requesting emergency services originating from a Wi-Fi Access Point (AP). Resources that may be controlled include but are not limited to bands, channels, AP transmission power levels, and Modulation and Code Schemes (MCS). The present system may be implemented in a cable MOS operator network.

### RELATED APPLICATIONS

This application is a continuation of U.S. patent application Ser. No. 14/945,267, filed Nov. 18, 2015, which application is incorporated herein by reference in its entirety.

### BACKGROUND

Reverse E911 is a service where the network pushes emergency services to, for example, mobile devices. Some examples of such reverse E911 services are Amber alerts via text and reverse 911 calls to home owners in natural hazards risk areas, such as those in immediate risk of a flood or wild fire. It is know that Reverse E911 communications can be location dependent and can be provided in multiple formats. For example, text is most common. Alerts are sequenced to mobile devices in a unicast fashion, or can be a cell broadcast in cellular systems.

In addition, in many instances devices common used to request emergency services are not connected to a cellular network. As such, a 911 call would fail. Therefore, a new method of communicating with emergency services is required which uses a separate wireless communication system.

### SUMMARY OF THE INVENTION

One embodiment of the present system is a Self-Organizing Network (SON) capable of reorganizing a communication network to provide communication resources to a device transmitting a communication requesting emergency services. The SON is formed with a first communication link for receiving data associated with the communication requesting emergency services handled by a first Wi-Fi Access Points (AP) and a second communication link for communicating with the first Wi-Fi AP and one or more other Wi-Fi APs not participant in the communication requesting emergency services. The system also includes one or more network reorganization components for reorganizing the network to provide resources to the device transmitting the communication requesting emergency services based on data received at the first communication link.

### BRIEF DESCRIPTION OF THE FIGURES

FIG. 1 shows one system for prioritizing 911 calls utilizing SON server, in an embodiment.

FIG. 2 is a flowchart illustrating one exemplary method for prioritizing 911 calls utilizing SON server, in an embodiment.

FIG. 3 shows one system for prioritizing emergency services utilizing SON server, in an embodiment.

FIG. 4 is a flowchart illustrating one exemplary method for prioritizing emergency services utilizing SON server, in an embodiment.

FIG. 5 shows a reverse E911 system implemented with a Self-Organizing Network (SON), in an embodiment.

FIG. 6 shows operator provisioned integrated E911 services, in an embodiment.

FIG. 7 user initiated integrated E911 services, in an embodiment.

FIG. 8 shows network initiated integrated E911 services, in an embodiment.

FIG. 9 is a flowchart illustrating one exemplary method for prioritizing emergency services over Wi-Fi utilizing SON server, in an embodiment.

### DETAILED DESCRIPTION OF THE FIGURES

Self-Organizing Networks (SON) are being actively deployed by a number of network operators. Cable Multiple-System Operators (MSO) are also looking to do the same. A SON has many advantages which results from its dynamic nature. One aspect of the present disclosure teaches leveraging the dynamic aspect of a SON in wirelessly communication enabled system. Such a system may be implemented as a Wi-Fi connected communication systems for handling communications (calls, text, etc.) for emergency services (police, fire, ambulance, disaster, terrorist attack, etc.).

The embodiment and examples disclosed here are described as having the Access Network Provider (ANP) and a Voice Service Provider (VSP) implemented on a Cable MSO system. Other implementation will be apparent to the skilled artisan without departing from the scope herein. In addition, the embodiment and examples disclosed here are described as implemented with a SON server having a centralized architecture. It will be understood by one skilled in the art that the SON algorithm may reside in a different location within the network without departing from the scope herein. For example the SON algorithm may reside in one or more network elements as in a distributed architecture or may reside partly in network elements and partly in the management system as in a hybrid SON architecture.

One embodiment of system and method utilizes a SON to allocate communication resources to provide prioritization to some communications, such as a 911 call, E911, 911 text, any request for emergency services, etc. The system for prioritizing emergency services within a SON may also be used in other aspects of emergency services communications, including but not limited to Reverse 911. For example, 911 calls made using a Wi-Fi enabled MSO network may be given the heightened, or even the highest priority. For example, communication between a Wi-Fi Access Point (AP) capable of communicating Wi-Fi layer unauthenticated emergency service requests and a SON Server may result in the SON server allocating resources for the device initiating the emergency service request. This may be used in conjunction with, or separately from the SIP server, discuss further below.

In another embodiment, the system for prioritizing emergency services within a SON may be configured to make use of a SON server to allocate the resources for an end user placing an emergency call over Session Initiation Protocol (SIP). No matter the traffic density on the network, a SON server can ensure that a call for emergency assistance (e.g., “911”) may be given the heightened priority.

In cases where a VSP is an OTT provider, a mechanism may be necessary such that the VSP operating in the ANP domain may communicate to the MSO's SON server such that the SON server can allocate resources to the a request for emergency services or reverse 911 communication.

One embodiment of the system and method implemented with a SON for allocating preferred resources is a system in which a first tier clientele is provided a heightened level of resources and a second tier clientele provided standard resources.

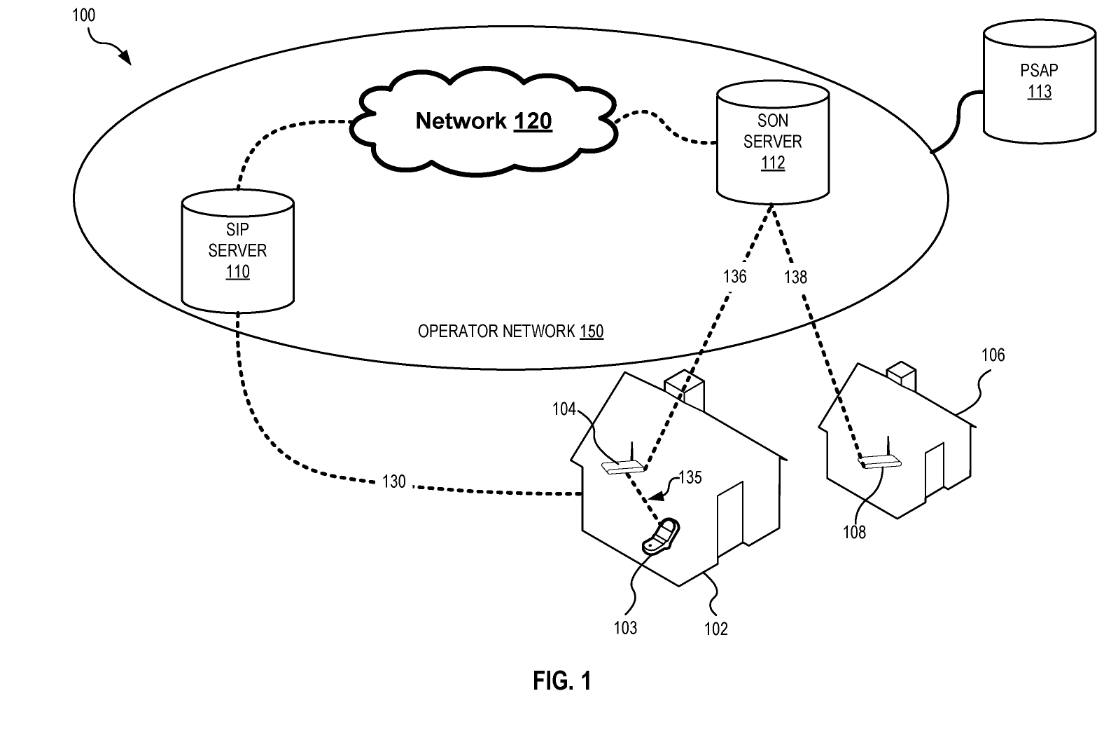

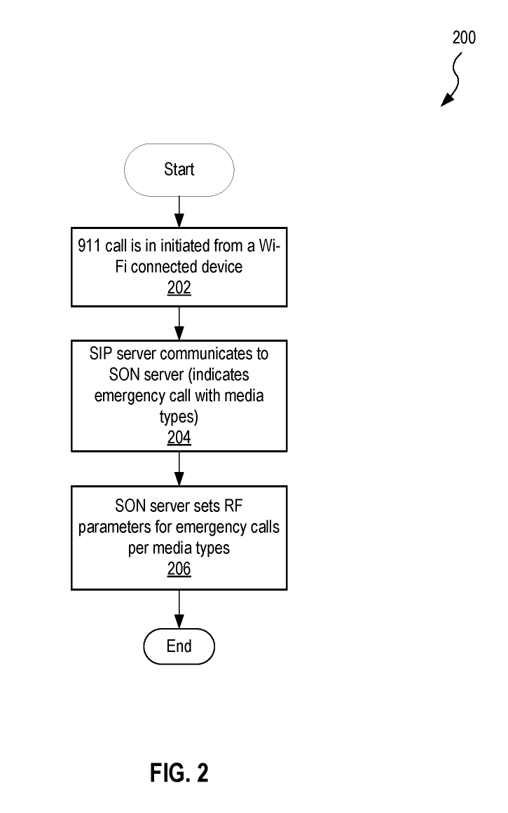

FIG. 1 shows a system for prioritizing a 911 call using SON server. FIG. 2 is a method for prioritizing a 911 call using SON server. FIGS. 1 and 2 are best viewed in combination.

FIG. 1 represents a system 100 configured for 911 prioritization such that additional resources are provided to emergency services related communications, for example, a request for emergency services. Emergency services related communications may include calls or text requesting emergency services, Reverse 911 calls, Reverse 911 data transmission (e.g., text), and a emergency services related callback.

In the embodiment of FIG. 1 two houses are shown in close proximity, each of which communicates with an operator network 150. Operator network 150 is configured with both a SIP server 110 and a SON server 112. Operator Network 150 is also in communication with a Public-Safety Answering Point (PSAP) 113. System 100 includes at least Wi-Fi access points (AP) 104 and 108 situated in house 102 and 106, respectively. AP 108 is shown in communication via communication channel 138 with SON server 112. AP 104 is shown in communication, via communication channel 136, with SON server 112 and in communication, via communication channel 135, with a Wi-Fi enabled phone 103. It will be understood that phone 103 may in fact be any Wi-Fi or wirelessly enabled communication device capable of establishing a communication connection with operator network 150 via AP 104. Phone 103 is also in communication, via communication channel 130, with SIP server 110, either by its own functionality or via its connection to AP 104. SIP server 110 facilitating multimedia communication sessions, such as internet telephony for voice and video, and messaging over an IP network for phone 103, as is well known in the art. SON server 112 and SIP server 110 communicate via network 120. Network 120 may be any network, including but not limited to the Internet. System 100 is shown with two APs for sake of simplicity and to facilitate understanding, but it will be understood by one skilled in the art that more APs may be included without departing from the scope herein.

SON server 112 is implemented with functionality for dynamically reorganizing communication within system 100. For example, SON server 112 may be capable of instructing adjacent APs (e.g., AP 108) to migrate to new channel. SON server 112 may also reduce the Modulation and Code Scheme (MCS) rates of non-essential traffic streams on the AP handling the call requesting emergency services (e.g., AP 104) and increase the MCS for the 911 call, for example, to its maximum. AP 104 may also be instructed by SON server 112 to operate in an enhanced mode, such as a beamforming mode, in cooperation with the device making the 911 call (e.g., phone 103). In the situation where there are multiple APs proximate one another, SON server 112 may reduce the transmit power of adjacent APs (e.g., AP 108) and increase the transmit power of the AP of interest (e.g., AP 104) to its maximum. SON server 112 may additionally exclusively link, for example, phone 103 to AP 104 such that no other device may establish a session with AP 104. SON server 112 may also reduce the transmit power to other devices (not shown) proximate to phone 103, for example, with in house 102, to provide additional opportunity of phone 103 to transmit. Any one or a combination of the above referenced functionality, and those not addressed here but know in the art, may be performed for the duration of the 911 call or emergency situation. Thereafter system 100 is set back to its original configuration or state or allowed to reorganize in manner unrestricted by SON server 112. Allocating recourse to APs and/or communication devices, such as phone 103, in this manner provides the APs and communication devices with more reliable service over a highly stable connection.

Below is a list of some of the parameters transmittable from the AP to the SON server:
Neighbor Information By Channel Scan
   SSID
   Channel Number and Bandwidth
   RSSI
Number of Associated Users
Channel Numbers and Bandwidth in Use
Supported Channel Number and Bandwidth
RF Power in Use
Supported RF Power Range
Beacon MCS Level in Use
Supported Beacon MCS Level
Operation Mode (b/g/a/n/ac) in Use
Supported Operation Mode (b/g/a/n/ac)
Carrier Sense Threshold in Use
Supported Carrier Sense Threshold Range
Channel Utilization
Number of Received/Sent Bytes
Number of Received/Sent Packets
Throughput
Traffic (Http, TCP) Quality of STASON
   One or more of these parameters may be used by SON server 112 to assist in the allocation of resources to AP 104, phone 103, and/or AP 108.

Below is a list of some of the parameters transmittable from SON server 112 to APs 104, 108.
Channel Numbers and Bandwidth
RF Power
Beacon MCS Level
Operation Mode (b/g/a/n/ac)
Carrier Sense Threshold
Maximum Associated STA for Admission Control
Maximum Packet Retry Count
RTS/CTS Exchange
Frame Aggregation Level
Data MCS Level (Auto, Fixed)
Noise/Interference Immunity Level
LNA Bypass

In one example, both AP 104 in house 102 and AP 108 in house 106 are utilizing channel 6. Phone 103 connected to AP 104 initiates a 911 call. The 911 call is handled by SIP server 110 via SIP signaling on communication channel 130. SIP server 110 is configured with a SIP-SON interface for transmitting 911 call data to SON server 112, which may include call data identifying that the 911 call originated from AP 104. Call data may be transmitted from SIP server 110 to SON server 112 via network 120. Since SON server 112 maintains information regarding all APs on its network, SON server 112 can determine the current channel sizes for all APs with which it is in communication with, may generate a list of neighboring AP proximate AP 104, may determine the transmit power of AP 104 and any neighboring APs, etc. SON server 112 will ensure AP 104 is provided with adequate resources, such as an appropriate amount of bandwidth such that a 911 call receives the highest priority. In some, but not all, instances providing an increased priority to an AP handling a 911 call may be at the determent of other APs and SON server associated devices.

In an embodiment, SON server 112 does not automatically provide increased resources to AP 104 or phone 103, but waits for instructions to do so from, for example, an emergency authority such as PSAP 113.

In another example, a call for emergency services originates from phone 103. A call requesting emergency services originating from phone 103 communicates with SIP Server 110 via a telephony client (not shown) via communication channel 130. Call data is sent from phone 103 to SIP server 110. Sip server 110 then transmits the call data to SON server 112 via network 120 via network 120. SON server 112 communicates with SIP server and APs 104, 108 to prioritize for phone 103. SON server 112 is configured to utilize the call data to control resources for phone 103 to facilitate, enhance, control, or otherwise augment communication and data transfer between phone 103, AP 104, and/or emergency services personnel, for example at PSAP 113.

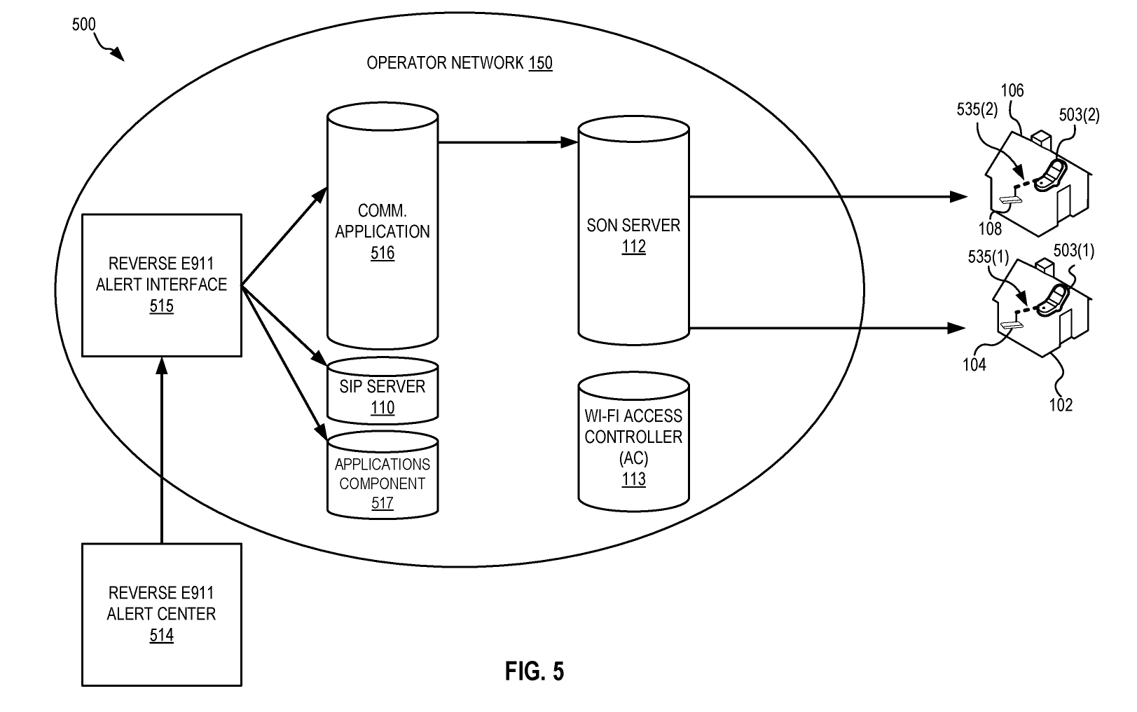

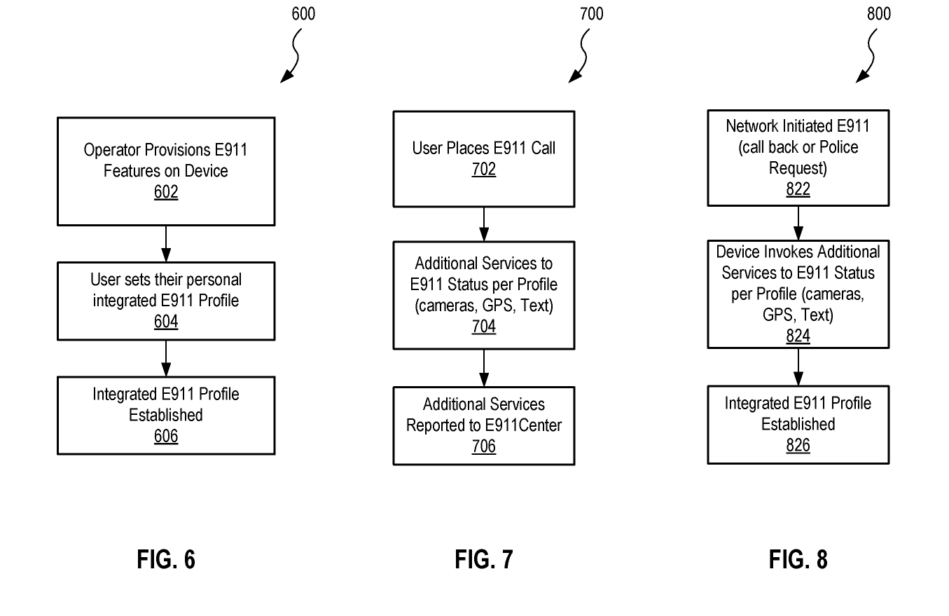

Facilitating, enhancing, controlling or otherwise augmenting communication and data transfer between phone 103 and/or AP 104 and emergency services personnel may include functionality dedicated to a self-organizing network, to the AP, or the device initiating the request for emergency services. Examples of such functionality include but are not limited to PSAP 113 access to phone 103 cameras, components, and software. See the description for FIGS. 5 and 6 for more details.

In an embodiment, a user may initiate a 911 call while roaming in an MSO-partner network. An MSO-partner network is a network controlled by an MSO with cooperative agreements with the users local MSO. “Roaming” here may be a user accessing a Wi-Fi network in an MSO's region which is outside the user's native region but covered by an agreement between the user's MSO and the MSO that controls the Wi-Fi network being accessed. A SIP server associated with the MSO-partners network may send a message that includes the details of the Wi-Fi AP that is serving the user's 911 call to an associated SON server in the MSO-partner network. In a similar embodiment, all MSO networks are partner networks, for example, based on governmental regulations.

In another embodiment, a user may initiates a 911 call in network that is outside the user's home network, for example, a community Wi-Fi network that is outside the home network. When a call is initiated from a community Wi-Fi network, the SIP server associated with the community network conveys the call, including any details regarding the Wi-Fi AP that is serving the user's 911 call, to a SON server associated with the community Wi-Fi network.

FIG. 2 shows one exemplary method 200 for managing prioritization of a call for emergency services.

In step 202 of method 200 a 911 call is initiated from a Wi-Fi connected device. One example of step 202 is a 911 call is initiated by phone 103, which is connected to AP 104 via a Wi-Fi connection. This call may or may not include credentials.

In step 204 of method 200 a SIP server communicates emergency call data to a SON server, which may include by way of example, media type information. One example of step 204 is SIP server 110 sending emergency call data to SON server 112 via network 120.

In step 206 of method 200 SON server sets RF parameters for emergency calls, for example, via media types. In one example of step 206, SON server 112 communicates with AP 104 to control RF parameters to facilitate the 911 call. In another example, SON server 112 communicates with AP 104 and AP 108 to control RF parameters to facilitate the 911 call.

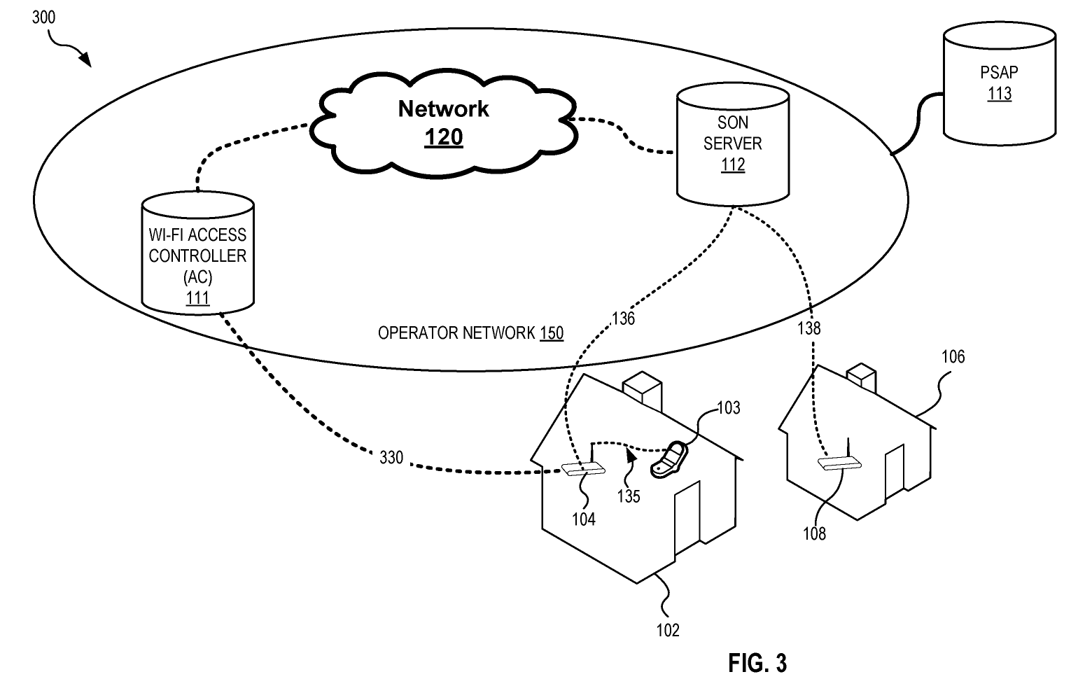

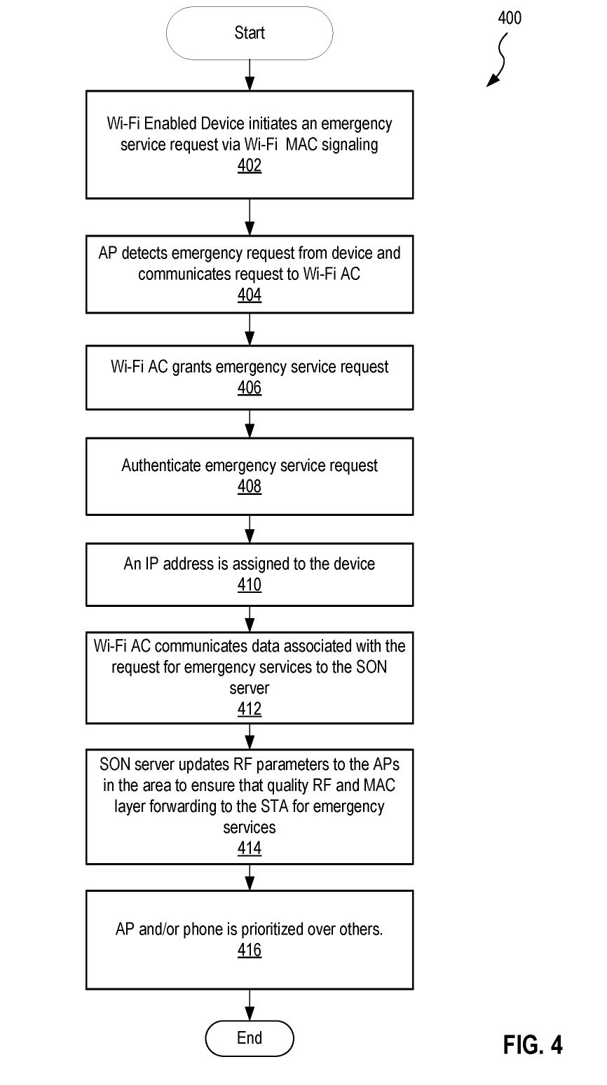

FIG. 3 details a system for prioritizing emergency services using a SON server in the absence of a SIP server. FIG. 4 details a method for prioritizing emergency services using a SON server, which may be implemented by the system of FIG. 3. FIGS. 3 and 4 are best viewed in together.

FIG. 3 is similar to FIG. 1, only differing in that FIG. 3 omits SIP server 110 for sake of clarity of illustration. FIG. 3 also differs from FIG. 1 in that it includes a Wi-Fi access controller (AC) 111 and an associated connectivity with AP 104. It should be understood that an embodiment of system 300 may be implemented with SIP server 110 without departing from the scope herein.

The system of FIG. 3 shows a system 300 configured for 911 prioritization such that additional resources are provided to emergency services related calls. AP 104 is shown in communication with AC 111 via connection 330. AC 111 is in communication with SON server 112 via network 120. A call requesting emergency services originating at Wi-Fi enabled phone 103 and connected to AP 104 has emergency services call data (also called herein “911 call data”) transmitted from AP 104 to AC 111. 911 call data may be process at AC 111 or remain “raw”. Processed or raw 911 call data is then sent via network 120 to SON sever 112. SON server 112 then controls its network as a function of the processed or raw 911 call data received over network 120 in a manner similar to that described above for system 100.

Devices that can initiate a request for emergency services (e.g., a 911 call) over a Wi-Fi network are sometimes called a station (STA) or Wi-Fi centric device. The devices described here are such devices and are discussed interchangeably as a device and a phone (e.g., phone 103), but may also be any Wi-Fi centric device, such as a tablet, a computer, a Wi-Fi and/or wireless enabled emergency services dedicated device, etc.

In one example, both AP 104 and AP 108 are operating on channel 6. MSO operating network 150 is implemented with a SIP server (not shown) and SON server 112. Phone 103 in house 102 attempts an unauthenticated emergency service MAC association to AP 104. AP 104 transmits an emergency service request from phone 103, and handled by AP 104, to Wi-Fi AC 111. Wi-Fi AC 111 grants access only for emergency services associated communications until the time that phone 103 is authenticated. AC 111 communicates to AP 104 that access is only granted for emergency services associated communications. Regardless of authentication, an IP address is assigned to phone 103 and emergency services are allowed to proceed. At this point in the process media types may not be known. MAC layer packets are forwarded with Priority.

SON server 112 may maintain information concerning channel sizes, a list of access points (AP), AP association and proximity to one another, transmit power of the active APs, etc. SON server 112 may ensure that it grants as much bandwidth as possible to an AP and/or device handling a call for emergency services by, for example, reducing any interference for that particular AP or device (e.g., AP 104 and phone 103) such that emergency services to the phone 103 are prioritized at the Wi-Fi PHY layer and MAC layer.

SON server 112 may be configured to include the following functionality:
Changing the channel of the AP handling the call for emergency services or any AP adjacent to the AP handling the call for emergency services, for example, APs 104 and 108.
Reducing the MCS rates of an AP traffic streams on AP 104.
Increasing to its maximum the MCS of the device initiating the 911 call to the max.
Beamforming to increase capacity available to the device initiating the 911 call.
Reducing the Tx power of the adjacent APs and bump the Tx power of the AP-A to the max. This would be done for the duration of the 911 call and then everything gets set to the original setup.

In one example, phone 103 requests E911 services via Wi-Fi AC 111, which triggers a process for controlling system 300 via SON server 112. SON server 112 may update the RF settings for APs 14, 108 based call information sent from SIP server (not shown) to SON server 112, which may include, by way of example, a description of the media types to be used for the E911 request. Alternatively, phone 103 may request E911 services via a SIP server (not shown).

In an embodiment, both Access Network Provider (ANP) and Voice Service Provider (VSP) are provided by one or more cable MSOs.

In one embodiment the VSP is provided by an OTT provider. In such an embodiment system 100, 300 may be configured such that the VSP operating in the ANP domain communicates to the MSO's SON server. In this way a SON server can allocate resources to ongoing emergency calls.

FIG. 4 shows a method 400 by which a SON system manages a request for emergency services over an operator network implemented with a Wi-Fi access Controller (AC) and prioritizes resources for the request for emergency services. It should be understood that the request for emergency services may be any communication conveyed over a communication system including a Wi-Fi aspect in some portion of its implementation. For example, a request for emergency services may be, but is not limited to, a call, a text, a video call, etc.

In step 402 of method 400 a Wi-Fi enabled device initiates an request for emergency service via Wi-Fi MAC signaling. In one example for step 402, phone 103 initiates a 911 call via Wi-Fi MAC signaling.

In step 404 of method 400 an Access Point (AP) detects the request for emergency services sent from the Wi-Fi enabled device and communicates the request to Wi-Fi AC. In one example of step 404 AP 104, which is in Wi-Fi communication with phone 103, detects the 911 call as a request for emergency services and communicates the request to Wi-Fi AC 111.

In step 406 of method 400 Wi-Fi AC grants the request for emergency services. In one example of step 406 Wi-Fi AC 111 recognizes the request as a request for emergency services via data transmitted with the request as dedicated to requests for emergency services.

In step 408, method 400 authenticates the request for emergency services. Authenticating the request for emergency services may be performed in parallel to forwarding the request to the appropriate authorities, such as a Public-Safety Answering Point (PSAP). One example of step 408 is system 300 authenticates the request for emergency services.

In step 410 method 400 assigns an IP address is to the Wi-Fi enabled device from which the request for emergency services originates. One example of step 410 is Wi-Fi AC 111 assigning phone 103 an IP address.

In step 412 of method 400 the Wi-Fi AC communicates data associated with the request for emergency services to the SON server. One example of step 412 is AC 111 sends data associated with the request to SON server 112 via network 120.

In step 414 of method 400 the SON server modifies parameters associated with one or more APs in communication with the SON server that are in the area of the AP handling the request for emergency services to ensure, for example, that signal quality is high, MAC layer forwarding to phone 103 for emergency services is maintained, etc.

In step 416 of method 400 the device from which the request originates is prioritized over devices. One example of step 416 is SON server 112 providing additional resources to AP 104 and/or phone 103, such as but not limited to bandwidth, clearing a channel for AP 104 and/or phone 103, dedicating a portion of the spectrum to AP 104 and/or phone 103, migrating other APs and devices away from the channel occupied by AP 104 and/or phone 103, etc. In one example, prioritizing the device from which the request originates may not account for media types requested at higher layers.

Reverse E911 with SON Server Broadcast

FIG. 5 shows a Reverse E911 system 500 implemented with a SON server for pushing a reverse E911 communication to one or more AP supported Wi-Fi enabled devices on a Wi-Fi network within an operator network 150. System 500 is shown including a reverse E911 alert center 514, a reverse E911 alert interface 515, a communication application component 516, a SIP server 110, an applications component 517, a SON server 112, and a Wi-Fi AC 113. FIG. 55 also shows houses 102, 106, which include APs 104, 108, respectively. AP 108 is in communication 535 with phone 503, which is similar to phone 103 of FIG. 1 and FIG. 3. It should be understood that in some embodiments operator network 150 is implemented with a Radio Resources Management (RRM) system (not shown), for example, configured with SON server 112.

Communication application 516 may be capable of communicating E911 text, voice, or other reverse E911 communications and/or notifications.

Reverse E911 alert center 514 is configured to communicate an E911 alert via a reverse E911 alert interface 515 to communication application 516, SIP server 110, and application component 517. Communication application 516 communicates with SON server 112 to facilitate reverse E911 communications with APs 104, 108 and or phones 103(1)-(2) in house 102, 106. SON server 112 utilized data from communication application 516 to adjust parameters of APs 104, 108 for alert delivery in broadcast, for example, by adjusting one or more of at least AP 104, 108 and or phones 103(1)-(2) channels, bands, etc. For example, a common broadcast channel is cleared for emergency services communications. In one embodiment, this is executed via a Wi-Fi controller, for example Wi-Fi access controller (AC) 113.

In one example, reverse E911 system 500 broadcasts a reverse E911 communication from reverse E911 alert center 514 to phone 503(1)-(2) within houses 102, 106. Reverse E911 alert center 514 sends an emergency alert to communication application 516 via reverse E911 alert interface 515 within the operator network 150. Communication application 516 generates an emergency alert. Generating an emergency alert may be, for example, forwarding the received emergency alert, repackaging the received emergency alert into an operator network 150 compatible format, or generating a new emergency alert based on data from the received emergency alert. These generating an emergency alert examples are meant to be non-limiting and may be accomplished in multiple ways as known in the art. Some operator network 150 compatible format include but are not limited to text, voice call, video pop-up, and video conference call. The communication application 516 generated emergency alert is then sent to SON server 112 and/or a RRM (not shown). SON server 112 (or RRM) updates the interface to prepare for reverse E911 alert to AP 104 and AP 108, either directly or via AC 113. The reverse E911 alert is sent from communication application 516 to SON server 112 and forwarded to APs 104, 108 which transmit the reverse E911 alert to phones 503(1)-(2). SON server 112 or RRM then clears the channels and the system is set back to it prior state or allowed to organically reconfigure.

In a separate example, operator network 150 of system 500 is a congested network. Such congestion requires modification to transmitting reverse E911 alerts. In a congested network reverse E911 system 500 pushes a reverse E911 communication from reverse E911 alert center 514 to phone 503(1) then to phone 503(2). Reverse E911 alert center 514 sends an emergency alert to communication application 516 via reverse E911 alert interface 515 within the operator network 150. Communication application 516 generates an emergency alert in a manner similar to that described above. The communication application 516 generated emergency alert is then sent to SON server 112 and/or a RRM (not shown). SON server 112 (or RRM) updates the interface to prepare for reverse E911 alert to AP 104, either directly or via AC 113. The reverse E911 alert is sent from communication application 516 to SON server 112 and forwarded to AP 104, which transmits the reverse E911 alert to phones 503(1). SON server 112 or RRM then clears the channels and the portion of the system associated with AP 104 is set back to it prior state or allowed to organically reconfigure. Then, SON server 112 (or RRM) updates the interface to prepare for reverse E911 alert to AP 108, either directly or via AC 113. The reverse E911 alert is sent from communication application 516 to SON server 112 and forwarded to AP 108, which transmits the reverse E911 alert to phones 503(2). SON server 112 or RRM then clears the channels and the portion of the system associated with AP 108 is set back to it prior state or allowed to organically reconfigure.

### Integrated E911 Services

FIG. 6 shows a method for an operator provisioned integrated E911 service, in an embodiment.

The integrated E911 concept teaches once an emergency status is invoked for one service that status is inherited by other services within the system. In an embodiment, this process is maintained until it is cleared, for example, by an emergency center, the user, etc.

In one embodiment, a user places an emergency call on a communication device, such as a Wi-Fi enabled phone. The device then applies emergency status to all other communications originating from the device. For example, any text, e-mail, etc. sent or received from the device is given emergency service status such that these communications are received/intercepted by an emergency center associated with the phone. An emergency center associated with the phone may be, for example, an emergency service center geographically associated with the device, i.e., the device is in the region controlled by the emergency service center.

In one embodiment, a user places an emergency call on a phone, but due to network problems, the emergency call is dropped. The emergency center handling that call initiates a call-back and activates remote control functionality, for example, to remotely activate phone's cameras and microphones. In an embodiment, initiating a call-back and activating remote control functionality are separate actions which do not rely on one another, e.g., if the user does not respond to the incoming call, the activating remote control functionality may still occur. Activating remote control functionality may control other aspects of the phone, for example, it may be used to turn on GPS for purposes of determining a location of the phone by emergency services center. Other aspects of the phone/device that can be controlled or provided data to the emergency service center include but are not limited to Bluetooth®, near field communication, Wi-Fi, thermometer, accelerometer, compass, software and firmware, etc. The emergency status may be cleared by the user or emergency center. Once cleared, emergency status is cleared for all services that previously inherited emergency status.

FIG. 6 shows one method 600 for setting up service provisioning in an integrated E911 system.

In step 602 of method 600 a network operator, such as a cable MSO provisions E911 features on a user's device.

In step 604 the user sets their personal integrated E911 profile. For example, the user may create their own integrated emergency profile by setting emergency service center access rights to their certain portions of their device, including but not limited to software (including app store applications, firmware, software, apps) and hardware (e.g., cameras, GPS, etc.).

In step 606 the integrated E911 profile is established such that when a request for emergency services is made from the device the emergency service center handling the request may have access to aspect of the device based on the user initiated profile.

FIG. 7 shows a user initiated E911 process 700 by which a request for emergency services results in the invocation of the user's integrated E911 profile for access to aspects of the device based on the profile.

In step 702 a user initiates a request for emergency services, for example, buy placing an E911 call.

In step 704 the users integrated E911 profile is access.

In step 706 the user's integrated E911 profile data is reported to the emergency service center handling the E911 call such that functional access to the device by the emergency service center handling the E911 call may occur.

FIG. 8 shows a network initiated E911 process 800 by which a request for emergency services results in the invocation of the user's integrated E911 profile for access to aspects of the device based on the profile. One example of a network initiated E911 process is a reverse E911 call back.

In step 822 a network initiates an E911, such as a call back or Police Request.

In step 804 additional services are invokes per the user's personal integrated E911 profile, discuss above for FIG. 6.

In step 806 the emergency service center handling the request for emergency services is provided access to the user's device based on the user's personal integrated E911 profile. It should be understood that the profile may provide different access for a network initiated E911 communication as compared to a user initiated E911 communication.

### Client Location for 911 Calls

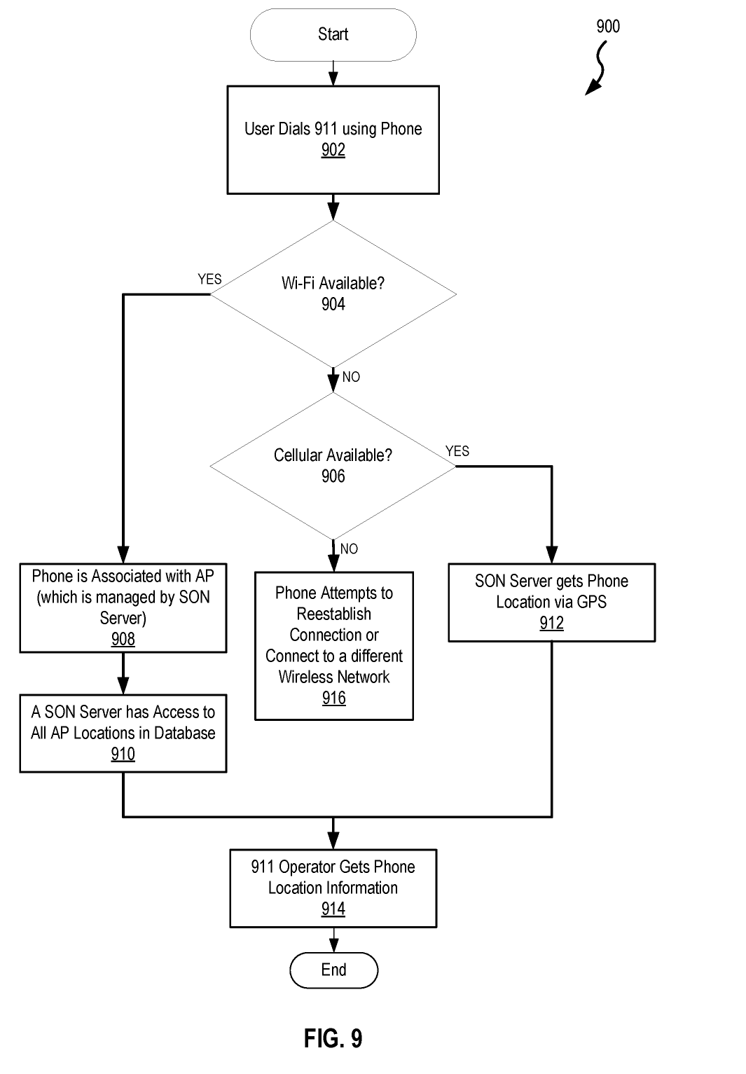

FIG. 9 is a method 900 for establishing a location of the device initiating the request for emergency services.

In step 902 of method 900 a user sends a request for emergency services (herein after, the “request”). One example of step 902 is a user dialing 911 on a Wi-Fi enabled phone connected to a cellular network.

In decision step 904 method 900 determines if a Wi-Fi network is available. One example of step 904 is Wi-Fi enabled phone determining if a Wi-Fi network is available. If it is determined that a Wi-Fi network is not available then decision step 904 moves to step 906, where method 900 determines if a cellular network is available. If it is determined in step 906 that a cellular network is available then method 900 sends the Wi-Fi enabled phone location to a SON server, as in step 912, and the operator gets the Wi-Fi enabled phone location as in step 914. If in step 906 it is determined that a cellular network is not available method 900 moves to step 916, where Wi-Fi enabled phone attempts to reestablish a connection via the Wi-Fi or Cellular network, which may restart method 900 or initiate a call-back from an emergency service center handling the call.

Returning to step 904, it is determined that a Wi-Fi network is available, method 900 moves to step 908, where which establishes an association between the Wi-Fi enabled phone and an Wi-Fi access point (AP) for handling the Wi-Fi connection. The Wi-Fi is managed by the SON server.

In step 910 of method 900 the Son server accesses its database of all APs on its network to determine a location of the AP handling the request from the Wi-Fi enabled phone. SON server transmits location in associated with the AP associated with the Wi-Fi enabled phone to the associated emergency service center handling the request.

In an embodiment, the SON server may additionally provide information regarding the location of the Wi-Fi enabled phone, such as distance information related to the distance of the Wi-Fi enabled phone from the AP based on, for example, signal strength of some other metric. The AP may also be capable of providing a relative direction of the Wi-Fi enabled phone from the AP, for example, based on beamforming information or some other metric know in the art.

### Prioritizing 911 Calls Over Wi-Fi

Also contemplated are optional functionalities for controlling resources in an emergency services enabled SON server system for prioritizing 911 calls over Wi-Fi, in an embodiment. These include channel steering, band steering, pausing client association, clearing channel, beamforming to target client, and automatic power control. Such functionality may provide additional network resources to a 911 call, which may lead to a cleaner channel, lower latency, and lower jitter for the 911 call. In addition, such functionality may facilitate a faster response by 911 operators and services.

Channel steering via control provided by a SON server controlling aspects of the network. For example, the SON server is aware of all the APs on its network and controls many aspects of the APs. When a user makes a request for emergency services via a device associated with an AP managed by the SON server, the SON server initiates the request on a channel, for example, channel 6. The SON server may give the request for emergency services on channel 6 a higher priority than all the other traffic by clearing channel 6 of all traffic not related to the request for emergency services.

The SON server can also steer the all other APs to other channels for the duration of the request on channel 6. In one example, a channel change command is sent by the SON server to all the APs not associated with the request. The APs not associated with the request then send a CSA (channel switch announcement) to their clients at which point the switch occurs.

Band Steering can also be utilized to provide additional resources being to a request for emergency services. In one example, for all the APs and clients that support multiple bands and not participating in the request for emergency services the SON server steers those APs to one or more adjacent bands for the duration of the request for emergency services, e.g., during the time a 911 call is in progress. The SON server maintains a database containing information associated with the RF footprint related to each channel in each of band. In an embodiment, the SON server utilizes this information to intelligently move the APs not participating in the request to different bands.

The SON server may also be implemented with functionality for pausing new client associations with one or more APs, for example, APs participating in a request for emergency services. That is, the SON server may prioritize a request for emergency services by not allowing APs involved in the request to accept new clients into their Wi-Fi network or not allowing any new clients on the network controlled by the SON server, except, for example, those provisioned by the emergency service center handling the request. For example, the SON server can instruct the AP handling the request to pause all new client associations for a period of time. Pausing all new client associations can be accomplished by turning off Wi-Fi beacons for a period of time, e.g., for the duration of the emergency call. Pausing all new client associations can also be accomplished by not responding to the client's probe requests. Thus the SON server ensures there is no additional management traffic overhead on the channel supporting the request.

Most legacy clients consume significantly more airtime than non-legacy clients which reduces the overall network throughput and increases the latency. In such a situation the SON server can clear the channel on which the request for emergency services is communicated. This may be accomplished by sending forceful dissociations to the legacy clients. By its association with the APs, the SON server is capable of maintaining a database of all the clients on its network. Thus the SON server knows which clients consume more airtime than the average and can dissociate those clients such the request for emergency services is prioritized.

The SON server may also be implemented with functionality to instruct the AP servicing a request for emergency services to beamform to the client initiating the emergency call. This can be done by forcing all the antennas to communicate with the client in a coordinated manner as known in the art.

SON server may also automatically control the power of some or all APs to prioritize a request for emergency services. For example, there may be cases where a client initiating a request for emergency services may be in a fringe area of the serving AP such that the connection between the AP and the client is not ideal. Such a situation may result in the communication operating at a suboptimal MCS. The SON server may be able to overcome such a problem by instructing the serving AP to increase its transmit power, for example, to its maximum limit, so such that the client is provided a communication link with improved SNR for the request for emergency services.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A Self-Organizing Network (SON) capable of reorganizing a communication network to provide communication resources to a device transmitting a communication requesting emergency services, comprising:
A first communication link for receiving data associated with the communication requesting emergency services handled by a first Wi-Fi Access Points (AP);
a second communication link for communicating with the first Wi-Fi AP and one or more other Wi-Fi APs not participant in the communication requesting emergency services;
one or more network reorganization components for reorganizing the network to provide resources to the device transmitting the communication requesting emergency services.

2. The SON of claim 1, wherein the SON is implemented as a SON server.

3. The SON of claim 1, wherein the SON is implemented as a distributed SON system with SON functionality distributed over a plurality of components within the network.

4. The SON of claim 1, wherein the SON is implemented as a hybrid SON architecture.

5. The SON of claim 1, wherein one of the one or more network reorganization components for providing additional resources to the device transmitting the communication requesting emergency services is a bandsteering component for instructing APs not participating in the communication requesting emergency services to clear the band.

6. The SON of claim 5, wherein instructing APs not participating in the request emergency services to clear the band is instructing the APs not participating in the communication requesting emergency services and any associated clients to migrate to a new band.

7. The SON of claim 1, wherein one of the one or more network reorganization components for providing additional resources to device transmitting the communication requesting emergency services is a channel steering component for instructing APs not participating in the request emergency services to clear the channel.

8. The SON of claim 1, wherein one of the one or more network reorganization components for providing additional resources to the device transmitting the communication requesting emergency services is a pause new client association component for restricting an AP involved in the communication requesting emergency services from accept new clients.

9. The SON of claim 1, wherein one of the one or more network reorganization components for providing additional resources to the device transmitting the communication requesting emergency services is a beamforming component for instructing the AP to utilize beamforming functionality to communicate with the device transmitting the communication requesting emergency services.

10. The SON of claim 1, wherein one of the one or more network reorganization components for providing additional resources to the device transmitting the communication requesting emergency services is a power control component for controlling AP power.

11. The SON of claim 10, wherein the power control component increases the power to the device transmitting the communication requesting emergency services improves the signal to noise ratio.

12. The SON of claim 10, wherein the power control component increases the power to the AC handling the communication requesting emergency services.

13. The SON of claim 10, wherein the power control component decreases the power to the AP not participating in the communication requesting emergency services.

14. The SON of claim 1, wherein one of the one or more network reorganization components for providing additional resources to the device transmitting the communication requesting emergency services is a Modulation and Code Scheme (MCS) control component for controlling the modulation and code scheme.

15. The SON of claim 1, wherein the device communicating the request for emergency services is the first Wi-Fi AP.

16. The SON of claim 1, wherein the device communicating the request for emergency services is a Wi-Fi enabled phone.

17. The SON of claim 1, wherein the device communicating the request for emergency services is selected from the group consisting of a computer, a tablet, and a Wi-Fi enabled emergency services dedicated device.
